(19) United States
(12) Patent Application Publication
(10) Pub. No.: US 2017/0102697 A1
(43) Pub. Date: Apr. 13, 2017

(54) SELECTING A VEHICLE FUNCTION TO CONTROL USING A WEARABLE ELECTRONIC DEVICE

(71) Applicant: General Motors LLC, Detroit, MI (US)

(72) Inventors: Elnajjar HASSAN, Dearborn, MI (US); Aditya S. KAMINI, Bloomfield Hills, MI (US); Nathaniel H. WILLIAMS, Berkley, MI (US)

(21) Appl. No.: 14/878,221

(22) Filed: Oct. 8, 2015

(51) Int. Cl. G05D 1/00; G06F 1/16; G06F 3/01

(52) U.S. Cl. CPC G05D 1/0016; G06F 3/017; G06F 1/163

(57) ABSTRACT

A system and method of selecting a vehicle function to control using a wearable electronic device includes: receiving, at a vehicle, an identity of a gesture that is associated with two or more vehicle functions and made using the wearable electronic device; identifying which of the two or more vehicle functions to control in response to receiving the identity of the gesture; and controlling the vehicle function.

### TECHNICAL FIELD

The present invention relates to detecting gestures made by vehicle occupants and, more particularly, to selecting a vehicle function to control using a wearable electronic device.

### BACKGROUND

Functions of a vehicle were traditionally controlled using control devices such as switches, buttons, or dials that receive physical input from a vehicle user and translate the input into control of a particular vehicle function, Vehicle functions, such as a vehicle audio system, a vehicle climate control system, or vehicle locks, have been controlled by physically receiving input at the control devices. This input can take the form of button selections, rotation of a dial by a desired amount in a particular direction, or depression of a switch, which all convey a vehicle user's input to the vehicle.

Vehicle functions can now be controlled without physically receiving input at the control devices described above. For example, the vehicle can detect the motion of an arm or leg belonging to the vehicle user and open a vehicle door or tailgate based on this motion. A unique motion made by the vehicle user may be associated with a vehicle function, such as the vehicle door/tailgate operation. Additional vehicle functions could benefit from motion-based control but it may be challenging to use a limited number of unique motions to control a significant number of different vehicle functions. While it is possible to attribute a unique arm or leg motion to each vehicle function, the vehicle user may not always recall which unique motion controlled which vehicle function or it may be difficult to detect the subtleties that distinguish one unique motion controlling one vehicle function from another unique motion controlling another vehicle function.

### SUMMARY

According to an embodiment of the invention, there is provided a method of selecting a vehicle function to control using a wearable electronic device. The method includes receiving, at a vehicle, an identity of a gesture that is associated with two or more vehicle functions and made using the wearable electronic device; identifying which of the two or more vehicle functions to control in response to receiving the identity of the gesture; and controlling the identified vehicle function.

According to another embodiment of the invention, there is provided a method of selecting a vehicle function to control using a wearable electronic device. The method includes receiving at a vehicle an identity of a gesture made using the wearable electronic device used by a vehicle user; receiving at the vehicle identities of two or more vehicle functions controlled by the gesture; storing the identity of the gesture with the identities of two or more vehicle functions; receiving, at the vehicle, data indicating the gesture was made using the wearable electronic device; identifying which of the two or more vehicle functions to control in response to receiving the data; and controlling the identified vehicle function.

According to yet another embodiment of the invention, there is provided a system of selecting a vehicle function to control using a wearable electronic device. The system includes a plurality of sensors located on a vehicle receiving data from the wearable electronic device via a short-range wireless communication protocol; and a vehicle microprocessor receiving the data from the plurality of sensors, wherein the vehicle microprocessor receives an identity of a gesture that is associated with two or more vehicle functions and made using the wearable electronic device, identifies which of the two or more vehicle functions to control in response to receiving the identity of the gesture, and transmits a computer-readable command that controls the identified vehicle function.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is perspective view of an embodiment of a system, including a vehicle and a plurality of sensors, that is capable of utilizing the method disclosed herein; and

FIG. 3 is a flow chart depicting an embodiment of a method of detecting movement of a wearable electronic device at a vehicle.

### DETAILED DESCRIPTION OF THE ILLUSTRATED EMBODIMENT(S)

The system and method described below uses a unique motion of the arm or leg of a vehicle user to control more than one vehicle function. The vehicle can receive the identity of a unique motion or gesture and then determine which of a plurality of vehicle functions the vehicle user is controlling based on a context in which the user makes the gesture.

A wearable electronic device can receive a. gesture made by a vehicle user. The vehicle user can then associate that gesture with two or more vehicle functions that will be controlled using the gesture. The gesture along with the vehicle functions that will be controlled using the gesture can then be stored for later access. When the wearable electronic device detects movement by a vehicle user or occupant that sufficiently matches a stored gesture, the vehicle can receive the identity of the gesture and determine which of the vehicle functions associated with the gesture the vehicle user wants to control. The vehicle can make this determination by detecting a context at the time the vehicle user makes the gesture. The context can include a variety of factors that the vehicle uses to infer that the gesture is associated with one vehicle function over another. For instance, context can include a distance of the vehicle user or wearable electronic device from the vehicle, the location of the vehicle user or wearable electronic device relative to the vehicle, or the last vehicle function controlled. The use of context to choose from vehicle functions associated with a single gesture will be discussed in more detail below.

### Communications System

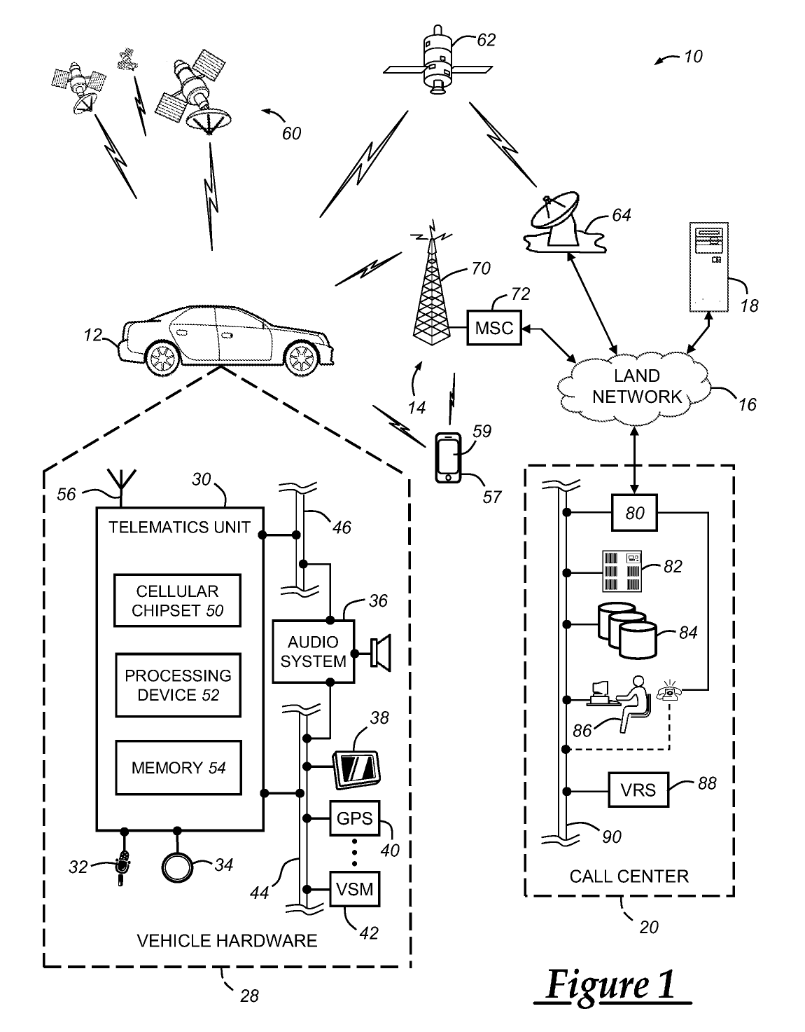

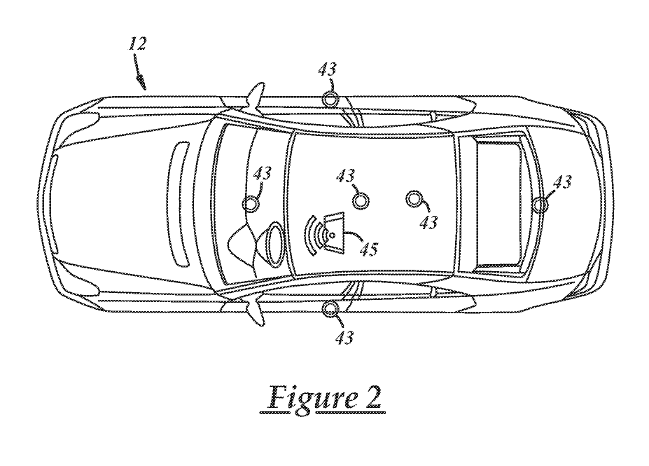

With reference to FIGS. 1-2, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should. be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a. GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM, CDMA, or LTE standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as LTE, EVDO, CDMA, GPS, and EDGE. Wireless networking between the vehicle and other networked devices can also be carried out using telematics unit 30. For this purpose, telematics unit 30 can be configured to communicate wirelessly according to one or more wireless protocols, including short range wireless communication (SRWC) such as any of the IEEE 802.11 protocols, WiMAX, ZigBee™, Wi-Fi direct, Bluetooth, or near field communication (NFC). When used for packet-switched data communication such as TCP/IP, the telematics unit can be configured with a static IP address or can set up to automatically receive an assigned IP address from another device on the network such as a router or from a network address server.

One of the networked devices that can communicate with the vehicle telematics unit 30 is a handheld wireless device, such as a smart phone 57. The smart phone 57 can include computer processing capability, a transceiver capable of communicating using a short-range wireless protocol, and a visual smart phone display 59. In some implementations, the smart phone display 59 also includes a touch-screen graphical user interface and/or a GPS module capable of receiving GPS satellite signals and generating GPS coordinates based on those signals. Examples of the smart phone 57 include the iPhone™ manufactured by Apple and the Galaxy™ manufactured by Samsung as well as others. These and other similar devices may be used or considered as a type of wireless device for the purposes of the method and system described herein. While the smart phone 57 is described as a wireless device used with the method/system, it should be appreciated that other similar and/or simpler wireless devices capable of short-range wireless communication can be successfully substituted for the smart phone 57 to carry out the method/system described herein. An iPad™ manufactured by Apple is an example of such a wireless device that may lack cellular communication capability of the smart phone 57 yet be able to communicate with the Wi-Fi network.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein. It should be appreciated that the processor 52 can initiate computer-readable commands that are sent over the communications bus 46 that control one or more vehicle functions, such as the audio system 34, as is known to those skilled in the art.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

The vehicle electronics 28 can also include a plurality of sensors 43 used to detect the existence of gestures made by a wearable electronic device 45, the location of the device 45, or both. The sensors 43 can be fixedly mounted at spaced apart locations at the vehicle 12 and aimed toward the interior or exterior of the vehicle 12. The sensors 43 can receive data included in wireless communications sent from the wearable electronic device 45 using one of several short-range wireless communications protocols, such as Bluetooth, and be communicatively linked to the communications bus 44. The data can include the identity of any one particular gesture. The processor 52 can then receive the data from the sensors 43 via the communications bus 44. The sensors 43 can be implemented using a variety of different technologies. In one implementation, the sensors 43 can be Bluetooth Low Energy (BLE) sensors. A plurality of BLE sensors can transmit short-range wireless signals to and receive the short-range wireless signals from the wearable electronic device 45 and those communications can be used to determine the location and/or distance of the wearable electronic device 45 to the vehicle 12 in addition to the identity of the gesture. As the location of the wearable electronic device 45 changes over time, the vehicle 12 can determine the distance or the location of the device 45 relative to the vehicle 12. The use of BLE sensors to determine angle of arrival of a wireless signal as well as the distance between the sensors and a wearable electronic device is known to those skilled in the art.

The wearable electronic device 45 is generally worn by a vehicle user or held in a way that movement of a human appendage, such as an arm or a leg, can be translated into information encoded in data that is used to control vehicle functions. The wearable electronic device 45 can detect a unique gesture made by the arm or leg by detecting the position of the device 45 over time in a way that closely monitors the vehicle user's movement. The wearable electronic device 45 can monitor motion of the user and when a gesture is detected, the device 45 can identify the gesture and/or the vehicle function to the vehicle 12 via the sensors 43. The wearable electronic device 45 can include one or more electromyographic (EMG) sensors that can evaluate electrical activity produced by skeletal muscle movement and encode the evaluation as data. The wearable electronic device 45 can recognize a number of pre-set gestures, such as waving left, waving right, tapping fingers, clenching a fist, or spreading fingers apart. In addition to pre-set gestures, the wearable electronic device 45 can learn other gestures that a user can design or create. A number of commercially-available wearable electronic devices exist, such as the Myo™ gesture control armband. However, other implementations of wearable electronic devices are possible, which include the Apple™ Watch and other quantified self electronic devices.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form. of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

### Method

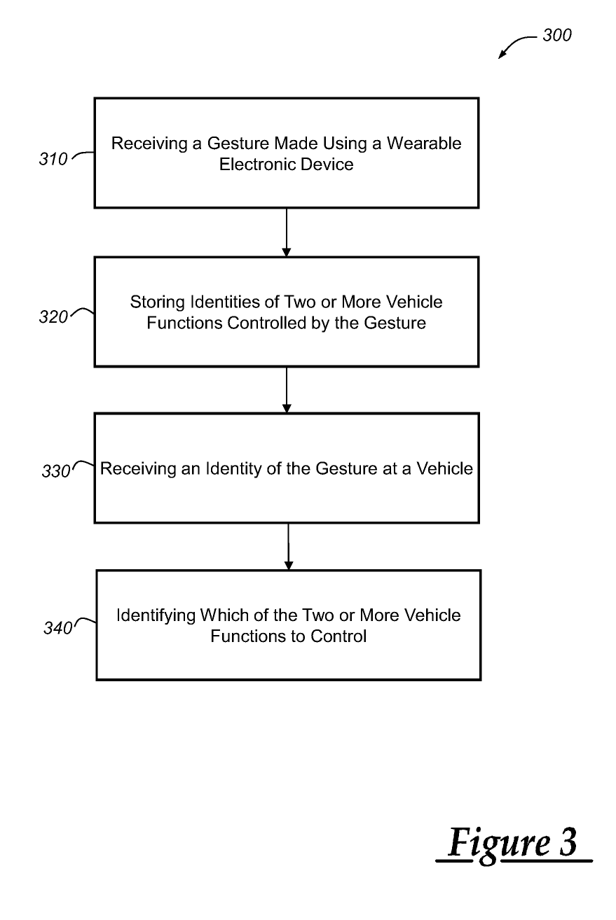

Turning now to FIG. 3, there is an implementation of a method 300 of selecting a vehicle function to control using the wearable electronic device 45. The method 300 begins at step 310 by receiving at the vehicle 12 a gesture made using the wearable electronic device 45. The vehicle user can initiate a learning mode that initiates the vehicle 12 for recording a gesture that is made by the user or selected from one of the pr-set gestures. A gesture can be a unique movement or a combination of unique movements of a human appendage in contact with the wearable electronic device 45 in one direction or several sequential directions at one or changing speeds. During the learning mode, the vehicle user can record a unique gesture for later detection to control a vehicle function.

In one example, after initiating the learning period, the vehicle user can create a gesture by holding his or her arm and wearable electronic device 45 at shoulder height such that the arm is parallel with ground and moving the arm until it is 45° with the ground. Or the vehicle user can start with his or her arm at 45° and move it until the arm is parallel to the ground. In another example, the vehicle user can create a gesture by holding his or her arm at shoulder height and moving their arm in a circular motion either in a clockwise or counter clockwise fashion in a way that mimics drawing a circle on a chalkboard. In addition to these directional movement of these gestures, the gestures can be differentiated by varying the speed at which the movement is carried out using the wearable electronic device 45. After making the gesture, the vehicle user can indicate to the wearable electronic device 45 that the created gesture is complete by selecting a pushbutton.

The amount of movement, the direction of movement, and/or the speed of movement can each be used as measured variables used to define a gesture. The sensors 43 can receive a short range wireless signal from the wearable electronic device 45 that identifies a gesture the device 45 detected. In addition, the vehicle 12 calculate the distance between the vehicle 12 and the device 45 based on the signal received at each sensor as well as the angle at which the sensor is received. Data reflecting the distance or the angle of arrival (AoA) can be transmitted from the sensors 43 to the microprocessor 52 to determine the motion of the wearable electronic device 45. And in addition to distance, the vehicle 12 can use the AoA and distance from multiple sensors 43 to the wearable electronic device 45 to determine the location of the device 45.

In one implementation, location of the wearable electronic device 45 can be determined at the vehicle 12 by calibrating the device 45 with the vehicle 12 before vehicle manufacture. Vehicle designers or engineers can systematically move the wearable electronic device 45 with respect to the vehicle 12, measure the location of the device 45, and then record the data produced by the sensors 43 receiving signals from the device 45. The location of the wearable electronic device 45 can then be stored in a lookup table with corresponding signal data. The vehicle 12 can later determine the location of the wearable electronic device 45 relative to the vehicle 12 by comparing data received from the sensors 43 to data in the lookup table and when a match is found, identifying the associated location of the wearable electronic device 45. The method 300 proceeds to step 320.

At step 320, identities of two or more vehicle functions controlled by the gesture are received at the vehicle 12 and stored. Once the vehicle user has created or selected the gesture, the vehicle user can associate and store two or more vehicle functions that gesture can control. Using the gesture examples above, it is possible the vehicle user may want to control the volume of the audio system 34 with the circular motion—clockwise may increase the volume while counterclockwise may decrease the volume. The volume control of the audio system 34 can be one vehicle function. The vehicle user can then associate another vehicle function with the circular motion, such as control of the windows in the vehicle 12. With regard to the latter vehicle function, a clockwise circular motion can move the windows up while a counterclockwise motion can move the windows down. In this example, control of the audio system 34 can be referred to as a first vehicle function while vehicle window control can be referred to as the second vehicle function. However, it should be appreciated that the systems and methods disclosed herein can be used with a gesture that is associated with more than two vehicle functions.

The gestures, along with their associated vehicle functions, can be stored locally at the vehicle 12 in the memory 54 or it is possible to store the gestures/vehicle functions away from the vehicle 12, such as at the smart phone 57. The method 200 can include the smart phone 57 for its ability to communicate with the vehicle 12 and the wearable electronic device 45 via short-range wireless protocols, provide computer processing capability instead of or in addition to processor 52, or store data. In implementations using the smart phone 57, the sensors 43 can receive signals from the wearable electronic device 45 and the vehicle 12 can wirelessly transmit the data received by the sensors 43 to the smart phone 57 via a short-range wireless link. The smart phone 57 can use its computer processing capabilities to carry out one or more steps of method 300 and then provide the processing output to the vehicle telematics unit 30 via the short-range wireless link. The method 300 proceeds to step 330.

At step 330, the gesture made using the wearable electronic device 45 is received. After one or more gestures have been created, the vehicle 12 can monitor both inside and outside the vehicle 12 via the sensors 43 for a signal generated by the wearable electronic device 45. The signal can include data indicating a gesture has been detected and the identity of the detected gesture. The vehicle 12 can then compare the identity of the gesture received from the wearable electronic device 45 to the gestures associated with vehicle functions. When gesture of the device 45 matches a gesture stored at the vehicle 12, the vehicle 12 can determine that the vehicle user is attempting to control a vehicle function using that gesture. The vehicle 12 can then identify the vehicle function(s) associated with the detected gesture and control the functions based on the gesture. Using the circular motion control of the audio system 34 volume as an example, the wearable electronic device 45 can detect the counterclockwise motion of the user's arm, and then transmit the identity of this gesture to the vehicle 12 via the sensors 43. The method 300 proceeds to step 340.

At step 340, the vehicle 12 identifies which of the two or more vehicle functions to control in response to detecting the gesture and controls the identified vehicle function. Depending on a context that exists at the vehicle 12, the gesture can be determined to control one of the vehicle functions that is associated with it. Given that one gesture is associated with more than one vehicle function, the vehicle 12 can identify which vehicle function the user intended to control based on the context existing at the time the gesture is detected by the wearable electronic device 45 or received at the vehicle 12. A number of variables can be used to determine the context at the vehicle 12, including the vehicle user's most-recent control of vehicle functions, distance or location of the wearable electronic device 45 to the vehicle 12, and the vehicle function last controlled with a physical control device (e.g., switch, button, or dial).

For example, when the vehicle 12 receives the identity of the gesture and has identified two or more vehicle functions associated with it, the vehicle 12 can determine which of the vehicle functions the user controlled last and select the most-recently controlled among them. Or the vehicle 12 can receive the gesture, determine where the wearable electronic device 45 is located, and then choose from the vehicle functions associated with the gesture based on the location. In the example above involving audio system and window control, the vehicle 12 could determine the vehicle user controlled the windows more recently than the audio system 34 and select the vehicle windows as the vehicle function to control. In another example, the gesture could be associated with control of the audio system 34 and locking/unlocking the vehicle doors. If the wearable electronic device 45 is determined to be located in the vehicle 12, it can be determined based on context that the user would like to control the audio system 34 whereas if the wearable electronic device 45 is outside of the vehicle 12, the user would like to lock or unlock doors. The method 300 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of selecting a vehicle function to control using a wearable electronic device, comprising the steps of:
(a) receiving, at a vehicle, an identity of a gesture that is associated with two or more vehicle functions and made using the wearable electronic device;
(h) identifying which of the two or more vehicle functions to control in response to receiving the identity of the gesture; and
(c) controlling the vehicle function identified in step (b).

2. The method of claim 1, wherein the identity of the gesture is received at the vehicle via one or more Bluetooth sensors.

3. The method of claim 1, wherein the gesture is a pre-set gesture recognized by the wearable electronic device.

4. The method of claim 1, further comprising the step of receiving a vehicle user-defined gesture at the wearable electronic device.

5. The method of claim 1, wherein step (b) is based on a most-recent control of vehicle functions, a distance between the wearable electronic device and the vehicle, or physical manipulation of a control device at the vehicle.

6. The method of claim 1, further comprising the step of transmitting data received from the wearable electronic device to a handheld wireless device via a short-range wireless communication link established at the vehicle.

7. The method of claim 1, further comprising the step of receiving the two or more vehicle functions from a vehicle user.

8. A method of selecting a vehicle function to control using a wearable electronic device, comprising the steps of:
(a) receiving at a vehicle an identity of a gesture made using the wearable electronic device used by a vehicle user;
(b) receiving at the vehicle identities of two or more vehicle functions controlled by the gesture;
(c) storing the gesture with the identities of two or more vehicle functions;
(d) receiving, at the vehicle, data indicating the gesture was made using the wearable electronic device;
(e) identifying which of the two or more vehicle functions to control in response to receiving the data; and
(f) controlling the vehicle function based on step (e).

9. The method of claim 8, wherein the data is received at the vehicle via one or more Bluetooth sensors.

10. The method of claim 8, wherein the gesture is a pre-set gesture recognized by the wearable electronic device.

11. The method of claim 8, further comprising the step of receiving a vehicle user-defined gesture at the wearable electronic device.

12. The method of claim 8, wherein step (e) is based on a most-recent control of vehicle functions, a distance between the wearable electronic device and the vehicle, or physical manipulation of a control device at the vehicle.

13. The method of claim 8, further comprising the step of transmitting data received from the wearable electronic device to a handheld wireless device via a short-range wireless communication link established at the vehicle.

14. A system of selecting a vehicle function to control using a wearable electronic device, comprising:
a plurality of sensors located on a vehicle receiving data from the wearable electronic device via a short-range wireless communication protocol; and
a vehicle microprocessor receiving the data from the plurality of sensors, wherein the vehicle microprocessor receives an identity of a gesture that is associated with two or more vehicle functions and made using the wearable electronic device, identifies which of the two or more vehicle functions to control in response to receiving the identity of the gesture, and transmits a computer-readable command that controls the identified vehicle function.

15. The system of claim 14, wherein the plurality of sensors communicate via Bluetooth.

16. The system of claim 14, wherein the vehicle microprocessor communicates with a handheld wireless device via short-range wireless communication protocols.
